(19) United States
(12) Patent Application Publication
(10) Pub. No.: US 2006/0114248 A1
(43) Pub. Date: Jun. 1, 2006

(54) Displaying apparatus and control method thereof

(76) Inventors: Dong-hoon Lee, Seoul (KR); Young-chan Kim, Uiwang-si (KR)

Correspondence Address: STANZIONE & KIM, LLP, 919 18TH STREET, N.W., SUITE 440, WASHINGTON, DC, 20006, US

(21) Appl. No.: 11/288,327

(22) Filed: Nov. 29, 2005

(30) Foreign Application Priority Data
Dec. 1, 2004 (KR) 2004-100032

(51) Int. Cl. G09G 5/00

(52) U.S. Cl. 345/204

(57) ABSTRACT

The present invention relates to a display apparatus including an input unit receiving a digital image signal and an analog image signal, a first storage unit storing digital display identification data, a second storage unit storing analog display identification data, a switching unit connecting the first storage unit or the second storage unit to the input unit, and a control unit controlling the switching unit so that display identification data having a priority is output through the input unit when the analog image signal and the digital image signal are simultaneously received.

### CROSS-REFERENCE TO RELATED APPLICATIONS

This application claims the benefit of Korean Patent Application No. 2004-0100032, filed on Dec. 1, 2004, which is hereby incorporated by reference for all purposes as if fully set forth herein.

### BACKGROUND OF INVENTION

1. Field of Invention

The present invention relates to a display apparatus and a control method thereof, and more particularly, to a display apparatus that improves display identification data transmission, and a control method thereof.

2. Description of the Related Art

According to rapid distribution of image display apparatuses formed with a liquid crystal display (LCD) panel, an interface between a display apparatus and an image source typically includes a digital signal interface mechanism from a conventional analog signal interface mechanism. Most LCD display apparatuses use a digital interface mechanism, e.g., a digital video interface (DVI) using a transition minimized differential signaling (TMDS) technology as a digital interface standard specified by a digital display working group (DDWG).

The display apparatus is connected with an external device having a graphic card using a digital mechanism as a DVI-I connector. The display apparatus transmits digital display identification data to the external device through a DVI-I port. A communication mechanism transmitting the display identification data of the display apparatus to an image source is referred to as a data display channel (DDC). The DDC function enables an automatic environment setting on an image display system, e.g., a plug and play method.

According to the DDC specification, a signal line and an order or priority for exchanging data is specified between an image source and a display apparatus. When an image source operates with a display apparatus supporting the DDC specification, the image source acquires data necessary for the plug and play method from the display apparatus by DDC communication.

FIG. 1 illustrates a configuration of a DVI-I connector. FIG. 2 illustrates a pin construction of the DVI-I connector.

As shown in FIG. 1 and FIG. 2, the DVI-I connector may have 29 pins of which digital signals may be input and output through 23 pins and analog signals may be input and output through 6 pins. For example, analog image signals, R/G/B/H/V, and analog ground signals may only be input and output through a pin #8 and pins #C1 through #C5. The pins through which image signals are input and output are not simultaneously operated but operate separate from one another. The DVI-I connector supports inputs of both analog signals and digital signals through this configuration of pins.

According to the DVI mechanism, signal lines used in DDC communication include DDC data lines used as bidirectional serial data lines and DDC clock lines used as clocks. As shown in FIG. 2, a DDC clock and a DDC data are transmitted through a pin #6 and a pin #7, respectively. An image source reads display identification data from the display apparatus through the pin #6 and the pin #7 .

FIG. 3 is a control configuration diagram describing a conventional display apparatus. The display apparatus 10 includes an input unit 14 and a storage unit 12.

The input unit 14 receives an analog image signal or a digital image signal from a DVI-I connector and outputs display identification data to the image source.

The storage unit 12 stores digital display identification data. Identification data generally refers to extended display identification data (EDID), which includes data relating a manufacturer, a product ID, specification, support timing, etc., of the concerned display apparatus.

Where a graphic card of an image source uses a digital mechanism, a display data processing device connects a display apparatus 10 and an image source with a DDC line through the input unit 14. The display apparatus 10 then outputs digital EDID to the image source according to control provided by a control unit (not shown). The image source then identifies features of the display apparatus 10 based on the EDID and outputs an image signal appropriate for the display apparatus 10 through the input unit 14. The storage unit 14 also outputs digital EDID to the image source when the graphic card of the image signal uses an analog mechanism.

An error in identifying EDID data may result when using the DVI-I based interface, which includes a digital channel and an analog channel, since there is only one kind of DDC line.

To solve this problem, a display apparatus has recently been developed that includes an analog EDID storage unit and a digital EDID storage unit, separately provided. However, this display apparatus is unable to determine whether to output an analog EDID or a digital EDID when an analog image signal and a digital image signal are simultaneously input. Further, even though two image signals are input, the display apparatus is unable meet a user request to output an EDID of a specific image signal.

### SUMMARY OF THE INVENTION

Accordingly, it is an aspect of the invention to provide a display apparatus and a control method thereof, capable of outputting display identification data as selected by a user to an image source when a plurality of image signals are inputted concurrently.

Additional features of the invention will be set forth in the description which follows, and in part will be apparent from the description, or may be learned by practice of the invention.

The present invention discloses an display apparatus including an input unit receiving at least one of a digital image signal and an analog image signal, a first storage unit storing digital display identification data, a second storage unit storing analog display identification data, a switching unit connecting the first storage unit or the second storage unit to the input unit, and a control unit controlling the switching unit so that display identification data having a priority is output through the input unit when the analog image signal and the digital image signal are simultaneously received.

The present invention also discloses a method of controlling a display apparatus, including establishing a priority, sensing whether an analog image signal and a digital image signal are simultaneously received through an input unit, and outputting display identification data having the established priority through the input unit when the analog digital image signal and the digital image signal are simultaneously received.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 shows a configuration of a DVI-I connector.

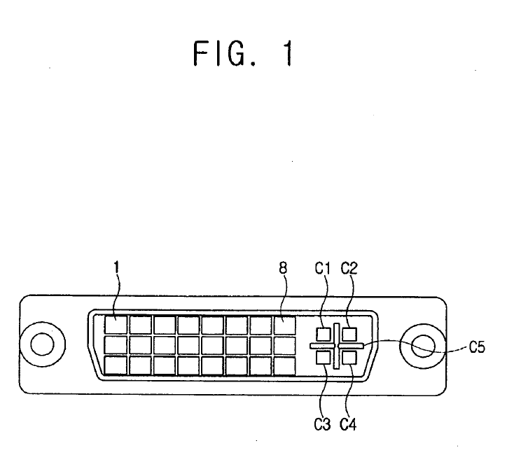

FIG. 2 shows a pin configuration of the DVI-I connector of FIG. 1

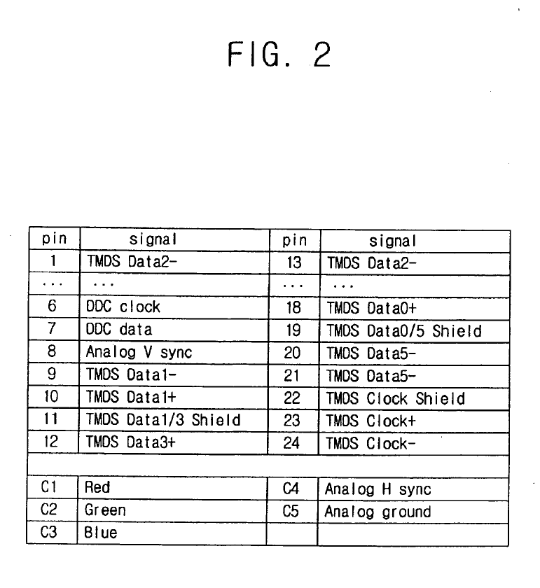

FIG. 3 is a control configuration diagram showing a conventional display apparatus.

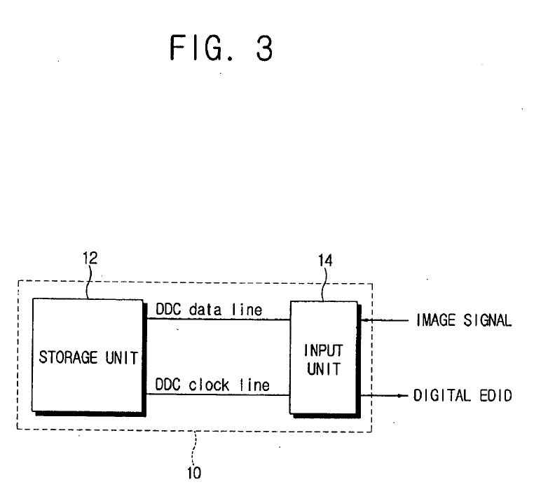

FIG. 4 is a control configuration diagram showing a display apparatus according to an embodiment of the invention.

FIG. 5 is a control flow chart describing the display apparatus according to an embodiment of the invention.

### DETAILED DESCRIPTION OF THE INVENTION

Reference will now be made in detail to the embodiments of the present invention, examples of which are illustrated in the accompanying drawings, wherein like reference numerals refer to like elements throughout. The embodiments are described below in order to explain the present invention by referring to the figures.

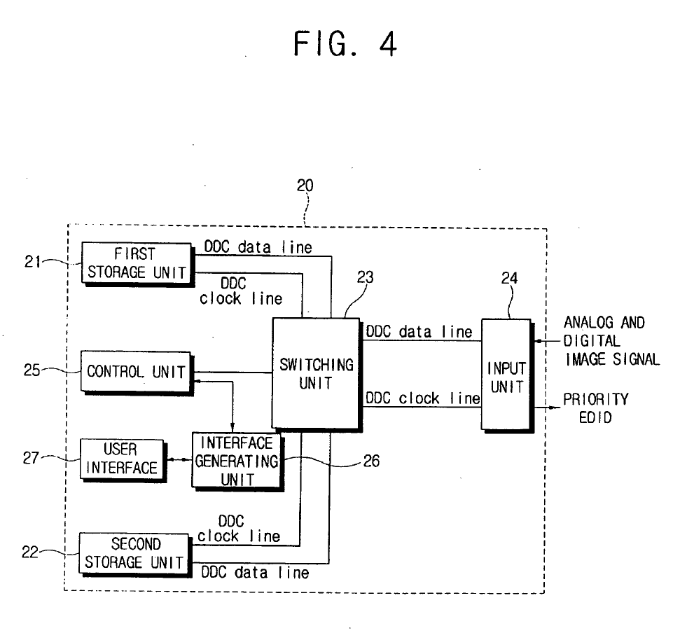

FIG. 4 is a control configuration diagram describing a display apparatus according to an embodiment of the invention. As shown in FIG. 4, a display apparatus 20 may include a first storage unit 21, a second storage unit 22, a switching unit 23, an input unit 24, a control unit 25, a user interface 27, and an interface generating unit 26.

The input unit 24 receives a digital image signal and/or an analog image signal from an image source, e.g., external image source. Therefore, for example, when a graphic card of the image source is used with the display apparatus 20, display identification data is output to the image source through the input unit 24. The input unit may include a DVI-I connector. The digital image signal and the analog image signal from two external image sources may be simultaneously received by using a Y cable through the DVI-I connecter. The DVI-I connector has a plurality of pin that is separated for the digital image signal and the analog image signal.

Further, according to another embodiment, the input unit 24 comprises a plurality of input terminal and receives a plurality image signal from an image source, e.g., external image source through the input terminals. Further, when a graphic card of the image source is used with the display apparatus 20, display identification data is output to the image source through the input unit 24. The input unit 24 comprises at least two terminals of a DVI-I, HDMI, DVI-D, RGB terminal, component terminal, S-video, D-sub. The input unit 24 receives a digital image signal through HDMI and DVI-D, an analog image signal through RGB terminal, component terminal, S-video, D-sub and both of digital image signal and/or an analog image signal through the DVI-l.

The first storage unit 21 and the second storage unit 22 are connected with the switching unit 23. The first storage unit 21 and the second storage unit 22 may be separately provided. The first storage unit 21 may store digital display identification data and the second storage unit 22 may store analog display identification data, or vice-versa. When the image source requests display identification data, the display identification data stored in the first storage unit 21 or the second storage unit 22 that is connected with the switching unit 23 is output.

The display identification data includes EDID regarding a manufacturer, a product ID, specification, support timing, etc., of the display apparatus.

The storage units 21 and 22 may each include a non-volatile memory inside the display apparatus. For example, the non-volatile memory may be an electrically erasable and programmable read only memory (EEPROM), a micro control unit (MCU), or the like.

The switching unit 23 switches to operate with the first storage unit 21 or the second storage unit 22. The switching unit 23 switches according to a control generated by the control unit 25 to enable display identification data to be output through the input unit 24.

When the control unit 25 senses that both analog and digital image signals are simultaneously received through the input unit 24, the control unit 25 controls the switching unit 23 so that display identification data having a priority is output through the input unit 24. The priority is established in advance between the digital display identification data and the analog display identification data and is only necessary when both the analog and digital image signals are simultaneously received through the input part. Otherwise, the priority is first-in-first-out.

35 DDC communication transmits display identification data, for example, EDID, and is made in two pins of a DDC data line and a DDC clock line even when the display apparatus supports the DVI-I mechanism,. Accordingly, although a plurality of image signals may be input into the display apparatus 20, display identification data associated with both the analog and the digital image signals cannot be output. Therefore, an embodiment of the invention controls the display apparatus to output display identification data for an image signal having a priority when a plurality of image signals are input.

The interface generating unit 26 establishes the user interface 27 on a display unit (not shown) so that a priority may be established, for example, by a user.

A user establishes a priority using the user interface 27, and priority information based on the user selection is output to the control unit 25. When a priority has been established for at least one image signal, display identification data of a desired image signal is output to the image source although a plurality of image signals may be input. Accordingly, there is little data interface between the display apparatus and the image source regardless of the format of the image signal currently being displayed. The priority may be determined and established by the user or specified by a manufacturer when the display apparatus is manufactured.

For example, when the digital image signal is established as the priority image signal over the analog image signal, digital display identification data established in advance is output to the image source more accurately and efficiently when the user converts the displayed image signal from analog to digital.

According to an embodiment of the invention, the display identification data with the established priority may be the digital display identification data because most image sources that request digital display identification data but receive analog display identification data are unable to display images.

When the plurality of image signal is input through the input unit 24, the control unit 25 controls the switching unit 23 so that display identification data corresponding to the image signal that is input may be output through the input unit 24. For example, when a single image signal is input, the control unit 25 enables display identification data of the image signal to be automatically output to the image source.

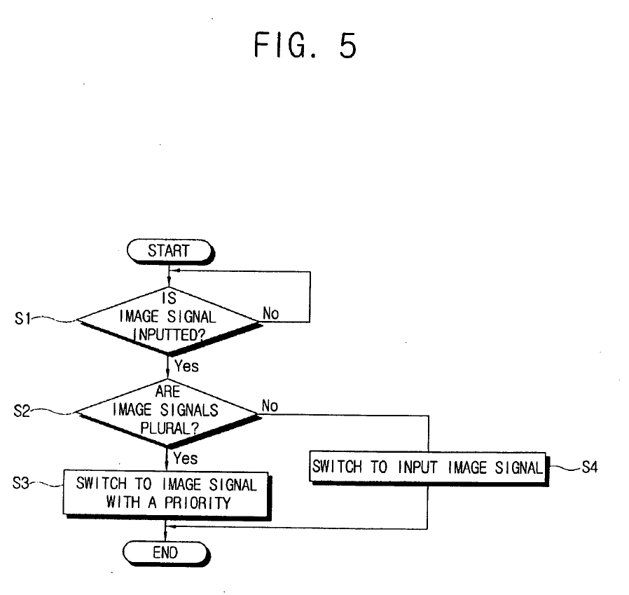

FIG. 5 is a control flow chart explaining the display apparatus according to an embodiment of the invention.

The control unit 25 determines whether an image signal is input at operation Si. The control unit then senses whether a plurality of image signals are input at operation S2. When an analog image signal and a digital image signal are simultaneously input, the switching unit 23 switches the storage units 21 and 22 according to the established priority and the display information data with the priority is output through the input unit 24at operation S3. The switching unit 23 is controlled by the control unit 25. However, when only one of the analog image signal or the digital image signal is input, the switching unit 23 switches to the corresponding storage unit at operation S4. The control flow described above is repeated by the control unit 25 and the switching control is made whenever an input image signal is generated.

As described above, according to the present invention, there is provided a display apparatus capable of outputting display identification data as selected by a user to an image source when a plurality of image signals are simultaneously imputed.

It will be apparent to those skilled in the art that various modifications and variations can be made without departing from the spirit or scope of the invention. Thus, it is intended that the present invention cover the modifications and variations of this invention provided they come within the scope of the appended claims and their equivalents.

What is claimed is:

1. A display apparatus, comprising:
an input unit receiving at least one of a digital image signal and an analog image signal;
a first storage unit storing digital display identification data;
a second storage unit storing analog display identification data;
a switching unit connecting the first storage unit or the second storage unit to the input unit; and
a control unit controlling the switching unit so that display identification data having a priority is output through the input unit when the analog image signal and the digital image signal are simultaneously received.

2. The apparatus of claim 1, wherein the input unit comprises a DVI-I connector.

3. The apparatus of claim 2, further comprising a Y cable is connected to the DVI-I connector.

4. The apparatus of claim 1, wherein the first storage unit stores digital extended display identification data (EDID) and the second storage unit stores analog extended display identification data (EDID).

5. The apparatus of claim 1, further comprising a user interface unit for establishing the priority according to a user selection.

6. The apparatus of claim 1, wherein the display identification data with the established priority refers to the digital display identification data.

7. The apparatus of claim 1, wherein the control unit controls the switching unit to output the display identification information through the input unit when the analog image signal or the digital image signal is received through the input unit.

8. A display apparatus, comprising:
an input unit having a plurality of input terminal for receiving an image signal;
a first storage unit storing digital display identification data;
a second storage unit storing analog display identification data;
a switching unit outputting one of the display identification data stored the first storage unit and the second storage unit to the input unit; and
a control unit controlling the switching unit so that display identification data having a priority is output through the input unit when a plurality of image signal are simultaneously received.

9. The apparatus of claim 8, wherein the input unit comprises at least two terminals of a DVI-I, HDMI, DVI-D, RGB terminal, component terminal, S-video, D-sub.

10. The apparatus of claim 8, wherein the first storage unit stores digital extended display identification data (EDID) and the second storage unit stores analog extended display identification data (EDID).

11. The apparatus of claim 8, further comprising a user interface unit for establishing the priority according to a user selection.

12. The apparatus of claim 8, wherein the display identification data with the established priority refers to the digital display identification data.

13. A method of controlling a display apparatus, comprising:
establishing a priority;
sensing whether an analog image signal and a digital image signal are simultaneously received through an input unit; and
outputting display identification data having the established priority through the input unit when the analog digital image signal and the digital image signal are simultaneously received.

14. The method of claim 13, wherein the input unit comprises a DVI-I connector.

15. The apparatus of claim 14, further comprising a Y cable is connected to the DVI-I connector.

16. The method of claim 13, wherein the first storage unit stores digital extended display identification data (EDID) and the second storage unit stores anolog extended display identification data (EDID).

17. The method of claim 13, wherein the display identification data with the established priority is the digital display identification data.

18. A method of controlling a display apparatus, comprising:
establishing a priority;
sensing whether a plurality, of image signal are simultaneously received through an input unit; and
outputting display identification data having the established priority through the input unit when the plurality of image signal are simultaneously received.
